(19) United States
(12) Patent Application Publication
(10) Pub. No.: US 2022/0117255 A1
(43) Pub. Date: Apr. 21, 2022

(54) MACHINE FOR MAKING LIQUID OR SEMI-LIQUID FOOD PRODUCTS

(71) Applicant: ALI GROUP S.R.L. - CARPIGIANI, Cernusco Sul Naviglio (Milano) (IT)

(72) Inventors: Roberto LAZZARINI, Reggio Emilia (IT); Federico TASSI, Bologna (IT)

(21) Appl. No.: 17/487,659

(22) Filed: Sep. 28, 2021

(30) Foreign Application Priority Data
Oct. 19, 2020 (IT) 202020000005821

(51) Int. Cl. A23G 9/22; A23G 9/12; A23G 9/04

(52) U.S. Cl. CPC A23G 9/222; A23G 9/224; A23G 9/045; A23G 9/12

(57) ABSTRACT

A machine for making liquid or semi-liquid food products, includes:
a first processing container for processing a liquid or semi-liquid base product and defining a processing chamber;
a stirrer for mixing the product in the first processing container;
a thermal system including a heat exchanger, associated with the first processing container;
a drive and control unit, connected to the stirrer and to the thermal system to control them;
a user interface including a display and a selection control configured to rotate and/or to be moved in at least one direction, the user interface being configured to allow selections to be made and, being connected to the control unit, to send commands for controlling the thermal system and the stirrer.

This application claims priority to Italian Patent Application 202020000005821 filed Oct. 19, 2020, the entirety of which is incorporated by reference herein.

### BACKGROUND OF THE INVENTION

This innovation relates to a machine for making food products for professional use.

A need that is felt particularly strongly by professional users is that for a machine for making liquid or semi-liquid products whose user interface is particularly easy to use and which, at the same time, avoids having to use a multitude of buttons.

In effect, as is known, recent regulations on the subject of health security recommend reducing the number of points of contact between operator and machine.

In this regard, a need to be met is that of being able to set the numerous functions of the food product making machine, that is to say, generally speaking, to be able to control the machine in a particularly practical and convenient manner.

### SUMMARY OF THE INVENTION

This innovation therefore has for an aim to meet the above mentioned need, specifically to provide a machine whose features make it easy to construct and user friendly.

A further aim of this innovation is therefore to provide a machine whose features include a user interface that is particularly robust and suitable for the environment in which it is made to operate, characterized by the presence of liquids and powders and by users whose hands are not clean and/or wet and/or who wear gloves or other protective equipment.

### BRIEF DESCRIPTION OF THE DRAWINGS

The technical features of the disclosure, with reference to the above aims, are clearly described in the annexed claims and its advantages are more apparent from the detailed description which follows, with reference to the accompanying drawings which illustrate an example, non-limiting embodiment and in which:

FIG. 1 is a schematic view of a first embodiment of a machine of this innovation;

FIGS. 2 and 3 are, respectively, a perspective view and a front view of a further embodiment of the machine;

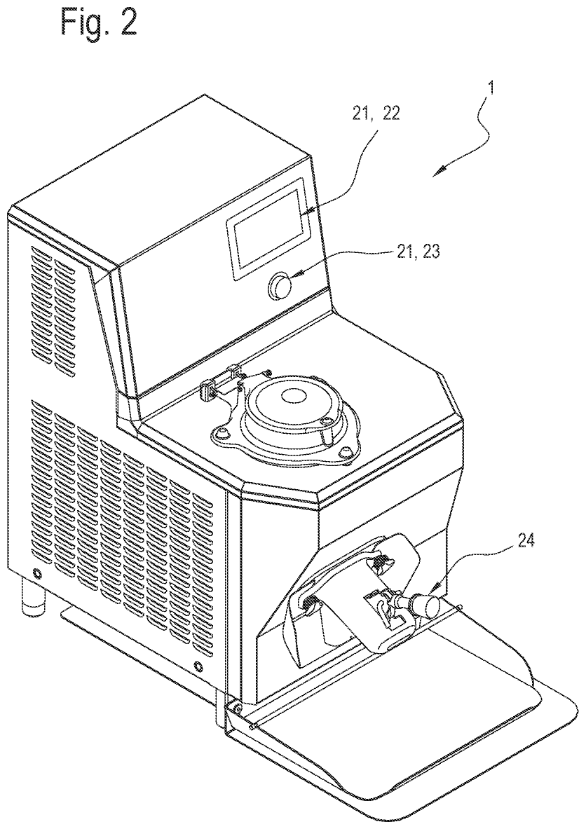

FIG. 4 schematically illustrates a detail of a part of the machines of the preceding figures;

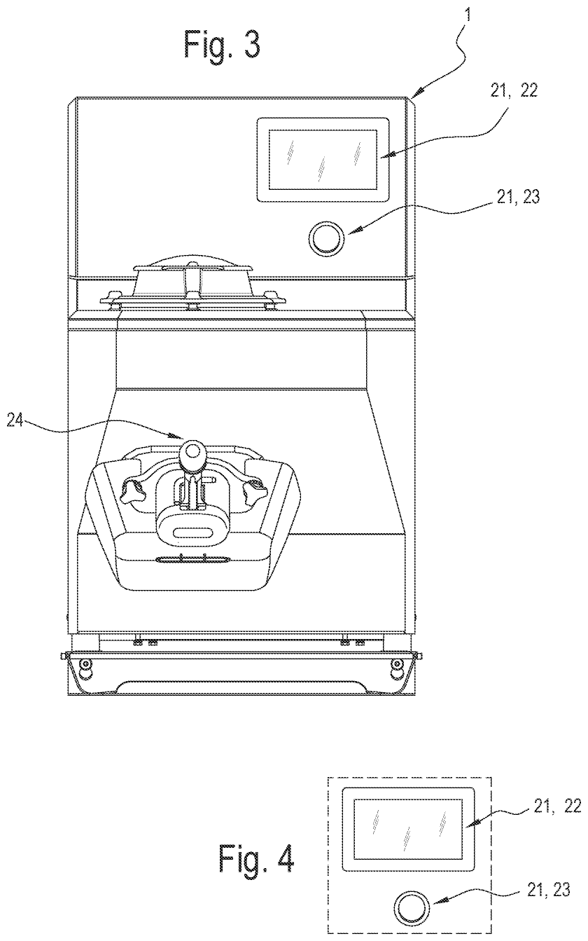

FIG. 5 illustrates a detail of another embodiment of the machine of FIG. 1;

FIGS. 6 and 7 schematically illustrate a detail from FIG. 5.

### DESCRIPTION OF THE PREFERRED EMBODIMENTS

With reference to the accompanying drawings, the numeral 1 denotes a machine for making liquid or semi-liquid food products according to this innovation.

The machine 1 is preferably configured to make ice cream, pastries and similar products (for example, but without limiting the scope of the innovation: gelato, soft serve ice cream, granita, sorbet, shake, yogurt, frozen dessert, chilled creams).

The machine 1 for making liquid or semi-liquid food products comprises:
a first processing container 2 for processing a liquid or semi-liquid base product and defining a processing chamber 3;
a stirrer 4 (preferably positioned inside the first container 2) for mixing the product contained in the first processing container 2;
a thermal system 5 comprising a heat exchanger 6, associated with the first processing container 2;
a drive and control unit 20, connected to the stirrer and to the thermal system to control them;
a user interface 21 comprising a display 22 and a selection control 23 configured to rotate and/or to be moved in at least two opposite directions, the user interface 21 being configured to allow selections to be made and, being connected to the control unit 20, to send commands for controlling the thermal system 5 and the stirrer 4.

According to another aspect, the thermal system 5 further comprises a compressor 14, a pressure reducing valve 15 and a further heat exchanger 16.

The thermal system 5 is, preferably, a thermodynamic system.

It should be noted, therefore, that the thermal system 5 comprises a closed circuit (including the exchanger 6, the compressor 14, a pressure reducing valve 15 and a further exchanger 16) in which a heat exchanger fluid circulates to run a thermodynamic cycle.

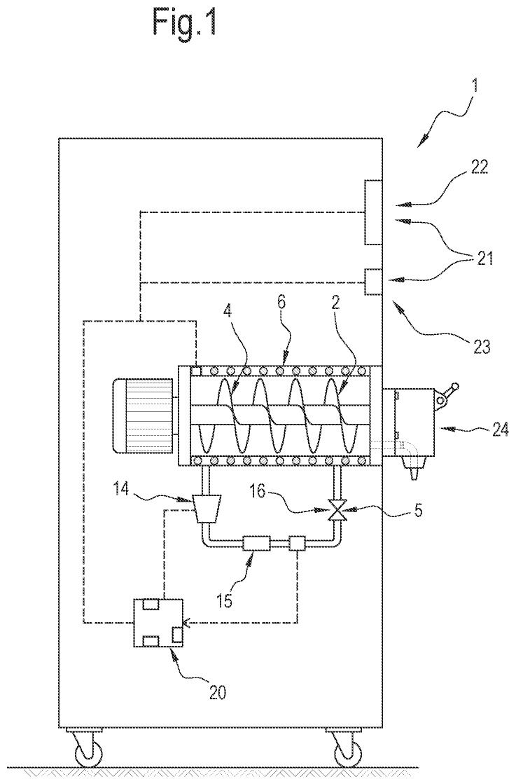

It should be noted that in the machine illustrated in FIG. 1, the heat exchanger 6 allows cooling the product being processed in the first container 2.

In embodiments not illustrated, the heat exchanger 6 allows heating the product. In this case, for example, the thermal system 5 may be a hot gas system or it may be a vapour compression system in which the heat exchanger 6 is “the condenser”.

It should be noted that the stirrer 4 mixes the product inside the first container 2 at substantially the same time as the thermal treatment (cooling/heating) carried out by the heat exchanger 6: that way, a liquid or semi-liquid food product is made.

Preferably, the machine 1 also comprises a dispenser 24 connected to the first container 2 to allow the product to be extracted.

According to an aspect, the selection control 23 is configured to rotate and/or be moved in a plurality of directions, preferably through an angle of 360°, in the same way as a joystick.

According to another aspect, on the other hand, the selection command 23 is configured to be moved in a plurality of orthogonal directions (discrete and non-infinite).

According to another aspect, on the other hand, the selection command 23 is configured to be moved in two orthogonal directions, one right-left direction and one forward-backward direction.

According to this aspect, the selection control 23 can advantageously be moved to four positions: right, left, forward, backward.

According to an aspect, the selection control 23 is configured to rotate and/or be moved in at least two opposite directions to allow a parameter and/or a processing cycle and/or a machine function to be selected and set on the display 22.

Advantageously, it is thus possible to make a selection in a particularly easy manner using a handy, intuitive control 23.

According to another aspect, the selection control 23 is configured to be pressed.

Advantageously, according to this aspect, it is possible, for example, to confirm the selection made.

According to yet another aspect, the display 22 is a touch display and is configured to allow viewing touch commands.

These commands allow extending the functions of the selection control 23.

In other words, the selection control 23 can act in conjunction with the display 22 to allow the user to select one or more options/commands that appear on the display 22.

According to another aspect, the selection control 23 is configured to be rotated (in one or both rotation directions) to allow scrolling through a plurality of selectable settings shown on the display 22.

According to another aspect, the selection control 23 is a protruding knob.

According to another aspect, the interface further comprises a plurality of additional buttons (physical).

According to another aspect, the interface further comprises a plurality of additional buttons (touch buttons made available by the display (22).

Advantageously, the machine 1 allows setting one or more machine cycles/processing parameters/functions in a particularly quick and easy manner: indeed, the selection control 23 is operable by the user in a particularly quick and easy manner and allows selecting and setting any of a plurality of parameters, machine cycles or machine functions.

Furthermore, the selection control 23 perfectly integrates the display 22 to allow the user to select and set quickly and easily any of a plurality of parameters, machine cycles or machine functions.

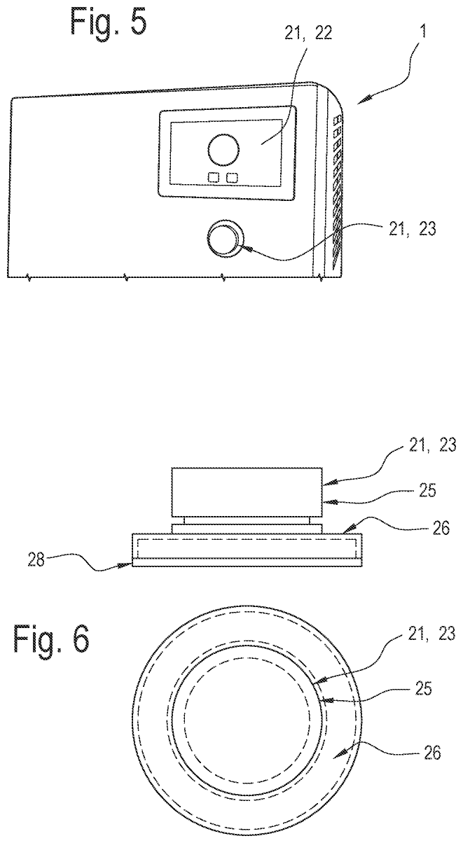

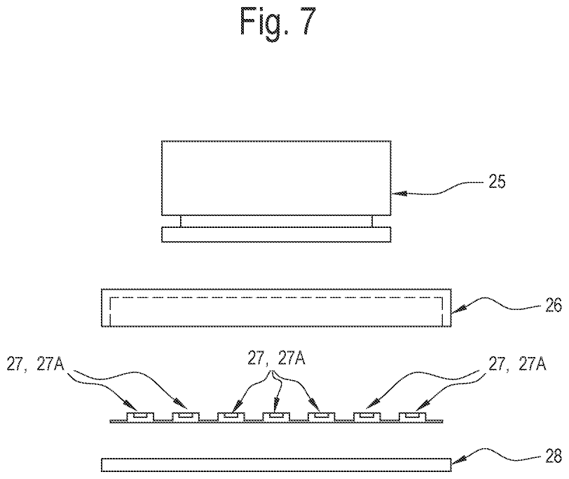

As illustrated in FIGS. 5-7, the selection control 23 is a protruding knob 25.

As shown clearly in FIG. 7, the protruding knob is surrounded by a transparent material 26.

Preferably, the transparent material is Plexiglas or glass.

It should also be noted that the machine 1 comprises light sources 27 under the transparent material.

Preferably, the light sources 27 are LEDs 27A.

Preferably, the LEDs are addressable LEDs.

Preferably, the LEDs 27A emit a white light or other coloured light (preferably, red or blue or green).

It should be noted that the LEDs 27A define a strip made up of a plurality of illuminated points.

Preferably, the LEDs 27A are held in place by a base 28, located under the transparent material 26 in such a way that the LEDs 27A are placed between the base 28 and the transparent material 26.

Thanks to the light sources, the machine 1 is able to create a plurality of illuminated graphical effects to define visual warnings, working aids, etc.

Preferably, the light sources 27 are connected to the control unit, which is thus able to drive them.

Thanks to the light sources 27, the lighting around the knob can follow the animations of the interface: for example, when loading is in progress, the frame lights up and follows the speed of loading, in the event of a serious alarm condition, a flashing red light switches on, etc.

This makes it easier to see what operations are being performed by the machine at any time; for example, in the event of an alarm, the flashing red light is visible even from a distance.

Advantageously, therefore, the presence of the light sources 27 make it possible to create a plurality of graphical effects or animations.

As is known, during the step of preparing the mixture, the control unit instantiates several timers, for example, to count the cooling time, the processing time, etc.

According to an aspect, in this situation, the control unit could progressively activate the LEDs in such a way as to create a lighting effect such that an object is illuminated to a greater extent (that is to say, which has, over time, a larger illuminated surface).

According to another aspect, when a recipe is finished, the light sources 27A start flashing in a predetermined colour (blue, for example) to indicate that the mixture is ready to be taken out.

According to another aspect, in the event of a malfunction or fault, the light sources 27 could flash in a predetermined colour (red, for example).

According to yet another aspect, in the event of a malfunction or fault, the light sources 27 could flash in a first predetermined colour (red, for example) if the problem belongs to a first category, and in a second predetermined colour (yellow, for example) if the problem belongs to a second category.

From the above it is evident that a multiplicity of graphical effects can be created thanks to a plurality of light sources placed beside the control 23.

Advantageously, the user interface 21 is particularly robust and suited to the environment in which it has to operate.

In effect, it should be noted that the selection control 23 (configured as set out in claim 1) can advantageously be operated even by a user wearing gloves, where other controls (physical buttons or touch buttons) might not work properly precisely because the user is hampered by the gloves.

Moreover, advantageously, the user interface 21 can operate correctly even in a dusty or grubby environment.

What is claimed is:

1. A machine for making liquid or semi-liquid food products, comprising:
a first processing container for processing a liquid or semi-liquid base product and defining a processing chamber;
a stirrer for mixing the product in the first processing container;
a thermal system comprising a heat exchanger, associated with the first processing container;
a drive and control unit, connected to the stirrer and to the thermal system to control them;
a user interface comprising a display and a selection control configured to rotate and/or to be moved in at least one direction, the user interface being configured to allow selections to be made and, being connected to the control unit, to send commands for controlling the thermal system and the stirrer.

2. The machine according to claim 1, wherein the selection control is configured to rotate to allow a parameter and/or a processing cycle and/or a machine function to be selected and set on the display.

3. The machine according to claim 2, wherein the selection control is configured to rotate in two opposite rotation directions.

4. The machine according to claim 1, wherein the selection control is configured to be moved in at least two directions to allow a parameter and/or a processing cycle and/or a machine function to be selected and set on the display.

5. The machine according to claim 4, wherein the selection control is configured to rotate in at least two orthogonal directions.

6. The machine according to claim 1, wherein the selection control is configured to be pressed.

7. The machine according to claim 1, wherein the display is a touch display and is configured to allow viewing touch commands.

8. The machine according to claim 1, wherein the selection control is configured to be rotated to allow scrolling through a plurality of selectable settings shown on the display.

9. The machine according to claim 1, wherein the selection control is a protruding knob.

10. The machine according to claim 1, comprising at least one element made of transparent material, adjacent to the selection control.

11. The machine according to claim 9, comprising at least one element made of transparent material, adjacent to the protruding knob and surrounding the protruding knob.

12. The machine according to claim 10, wherein the transparent material is Plexiglas or glass.

13. The machine according to claim 1, comprising a plurality of light sources.

14. The machine according to claim 13, wherein the light sources are LEDs.

15. The machine according to claim 13, wherein the light sources are located in proximity to the selection control.

16. The machine according to claim 10, wherein the light sources are located under the element made of transparent material.

17. The machine according to claim 13, wherein the light sources are driven by the control unit.

18. The machine according to claim 10, comprising a base, located under the element made of transparent material.

19. The machine according to claim 13, wherein the light sources are located between the base and the element made of transparent material.

20. The machine according to claim 1, further comprising a plurality of additional buttons.

21. The machine according to claim 20, wherein the additional buttons are physical buttons.

22. The machine according to claim 20, wherein the additional buttons are touch buttons made available by the display.
